(19) United States
(12) Patent Application Publication
(10) Pub. No.: US 2010/0088166 A1
(43) Pub. Date: Apr. 8, 2010

(54) Electronic Coupons

(75) Inventor: Preston Tollinger, Los Altos, CA (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: Cellfire, Inc., San Jose, CA (US)

(21) Appl. No.: 12/574,179

(22) Filed: Oct. 6, 2009

Related U.S. Application Data
(60) Provisional application No. 61/103,213, filed on Oct. 6, 2008.
(60) Provisional application No. 61/103,216, filed on Oct. 6, 2008.

(51) Int. Cl. G06Q 30/00

(52) U.S. Cl. 705/14.13; 705/14.38

(57) ABSTRACT

System and method of creating, managing, validating, associating and redeeming electronic coupons are disclosed. An electronic coupon system is capable of creating, delivering and distributing coupons to at least one user. The system is also capable of identifying, verifying and associating the coupon with the user, and further allowing the coupon to be redeemed by the user at a third-party vendor.

### CROSS-REFERENCE TO RELATED APPLICATIONS

This application claims priority to U.S. Provisional Application Ser. Nos. 61/103,213 and 61/103,216, both filed Oct. 6, 2008, and both of which are incorporated herein by reference in its entirety for all purposes.

### BACKGROUND

Coupons can be used to stimulate consumers into purchasing certain products by creating product awareness, prompting product trials, and/or rewarding repeat product purchases. However, the production, distribution and redemption of coupons can be costly. Furthermore, aside from the inefficiencies associated with this practice, coupon fraud may also be a concern. In some instances, consumers may be confused by the coupons thereby frustrating the intended purpose of the coupons and undermining consumption of the desired products.

### SUMMARY

System and method of creating, managing, validating, associating and redeeming electronic coupons are disclosed. One embodiment discloses a system for creating and managing coupons, the system comprising: a central coupon module capable of creating a coupon, wherein the coupon comprises a coupon content; an integration module in communication with the central coupon module, wherein the integration module comprises a plug-in unit, and wherein the plug-in unit is configured to verify the coupon content; and a point-of-sales (POS) module in communication with the plug-in unit of the integration module, wherein the POS module is capable of receiving the coupon content from the integration module via the plug-in unit.

In one embodiment, the coupon content includes at least one of coupon type, coupon category, coupon format, coupon location, coupon demographics and coupon value. In one embodiment, the plug-in unit is operable to transmit the coupon content from the central coupon module to the POS module in a common format. In one embodiment, the POS module is operable to transmit utilization of the coupon content to the central coupon module via the integration module.

One embodiment discloses a method of distributing coupons, the method comprising: (a) inputting a coupon content by a first user; (b) matching the coupon content to a plurality of coupons; (c) assigning a score to each of the plurality of coupons based on the matching step (b), wherein each score is assigned based on matches directed to at least one of coupon type, coupon category, coupon format, coupon location, coupon demographics, coupon keyword and coupon value; and (d) displaying each of the plurality of coupons based on the assigned scores from the assigning step (c) to a second user.

In another embodiment, concomitant to the inputting step (a), the method includes authenticating the status of the first user. In one embodiment, the coupon content comprises at least one of coupon type, coupon category, coupon format, coupon location, coupon demographics and coupon value. In one embodiment, concomitant to the assigning step (c), the method includes ranking the scores from highest to lowest. In one embodiment, concomitant to the displaying step (d), the method includes authenticating the status of the second user. In one embodiment, concomitant to the displaying step (d), the method includes filtering the coupons that did not reach a confidence level during the matching step (b). In one embodiment, the confidence level is at least about 80%.

Other variations, embodiments and features of the present disclosure will become evident from the following detailed description, drawings and claims.

### BRIEF DESCRIPTION OF THE DRAWINGS

FIG. 1 illustrates a block diagram of an electronic coupon system according to one embodiment of the present disclosure;

FIG. 2 illustrates a block diagram of a POS (point-of-sales) integration system (PIS) within the electronic coupon system of FIG. 1;

FIG. 3 illustrates a flow diagram of creating and managing coupons; and

FIG. 4 illustrates a flow diagram of validating user identifier.

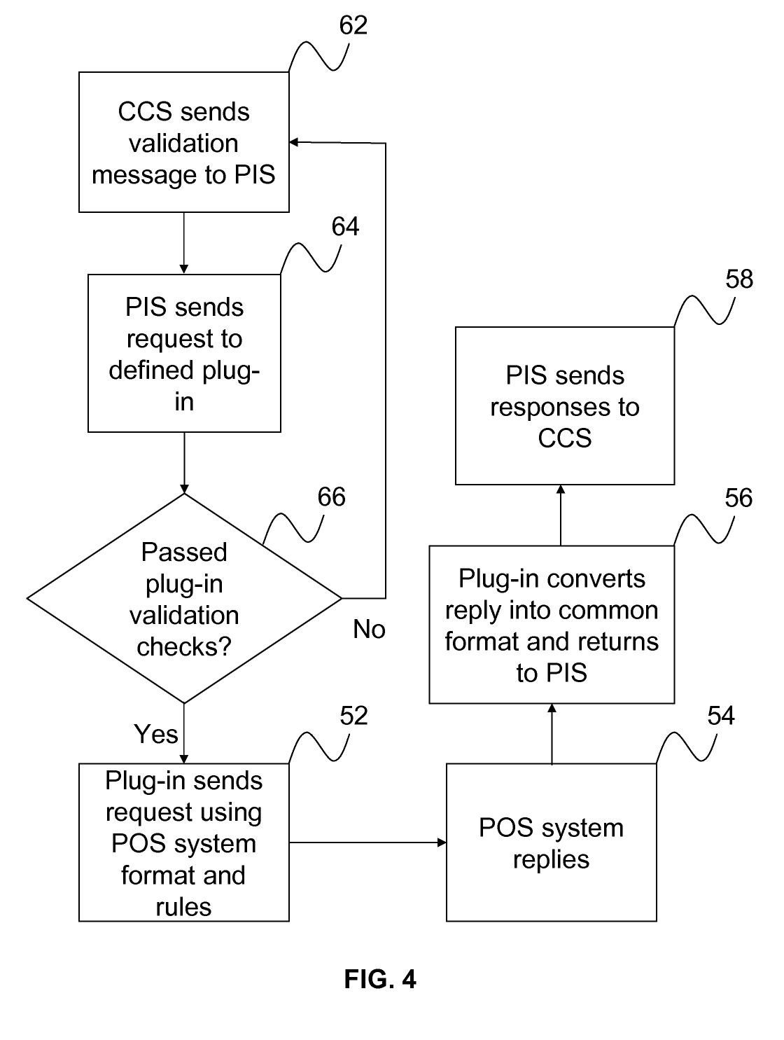

### DETAILED DESCRIPTION

It will be appreciated by those of ordinary skill in the art that the invention can be embodied in other specific forms without departing from the spirit or essential character thereof. The presently disclosed embodiments are therefore considered in all respects to be illustrative and not restrictive.

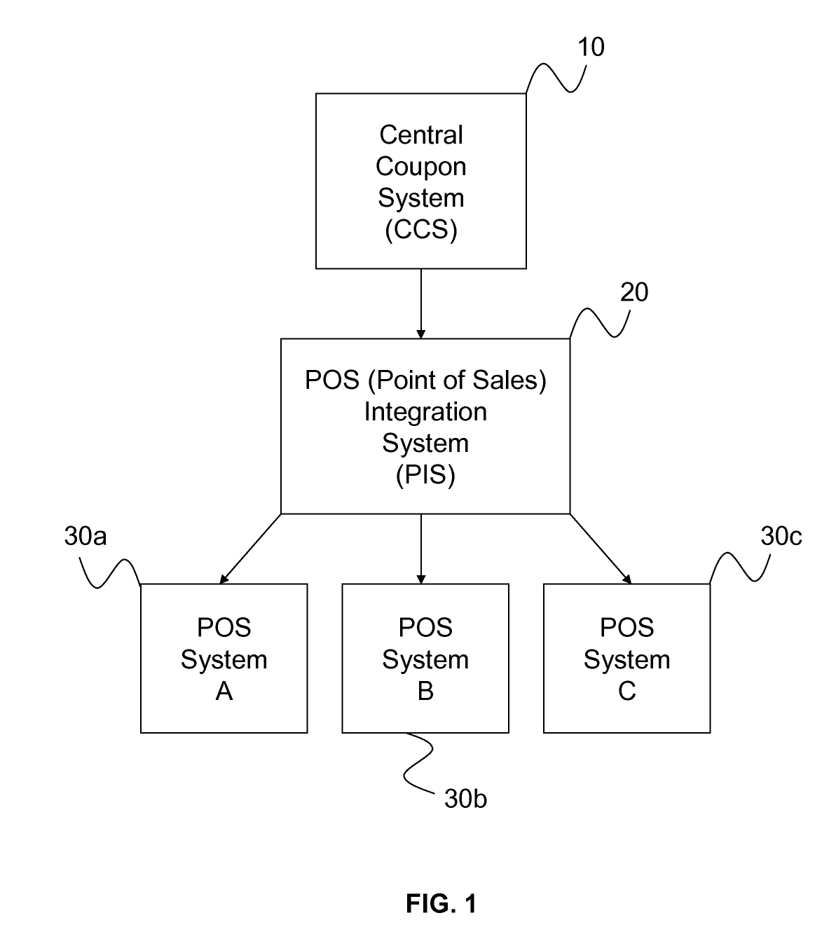

Reference is now made to FIG. 1 illustrating a block diagram of a central coupon system (CCS) 10 coupled to a plurality of point-of-sales (POS) systems 30 via a POS integration system (PIS) 20. In some embodiments, the POS systems 30 include third-party system controllers and backend management systems. The CCS 10 allows targeting of one-on-one offers to be created and associated with a specific user or class of users, whereby the offers are capable of being redeemed at one or more POS systems 30. In some embodiments, each POS system 30 includes without limitation, a central server, store-level servers and store terminals (not shown). In one example, the CCS 10 has an internal format and/or language that can be converted to protocols specific to each POS system 30, and whereby the protocols may be communicated in a common format and/or language to each POS system 30 via the PIS 20.

In one embodiment, the CCS 10 includes, among others, four generalized interactions: coupon creation and management, user identifier validation, coupon association and redemption report. Regardless of how each POS system 30 operates and whether certain actions and/or commands are supported, the four interactions described above may be translated into processes and/or formats that are commonly understood by any POS system 30. In one embodiment, the translation can be carried out by the PIS 20. In some embodiments, the CCS 10 uses these four interactions as the basis for how the CCS 10 processes and communicates with each POS system 30. When a process command for carrying out one of the four interactions has been received from the CCS 10, the PIS 20 will, in turn, convert the process command into POS specific request or requests in completing the command action before returning at least one response to the CCS 10. In other words, the PIS 20 functions like a relay system in sending commands out to each POS system 30, receiving feedback responses from each POS system 30, and sending the corresponding feedback responses back to the CCS 10. In one embodiment, the PIS 20 may also extract any specific interactions, communication channels and/or processes, as well as the synchronous and/or asynchronous nature of the communication with each POS system 30 and with the CCS 10.

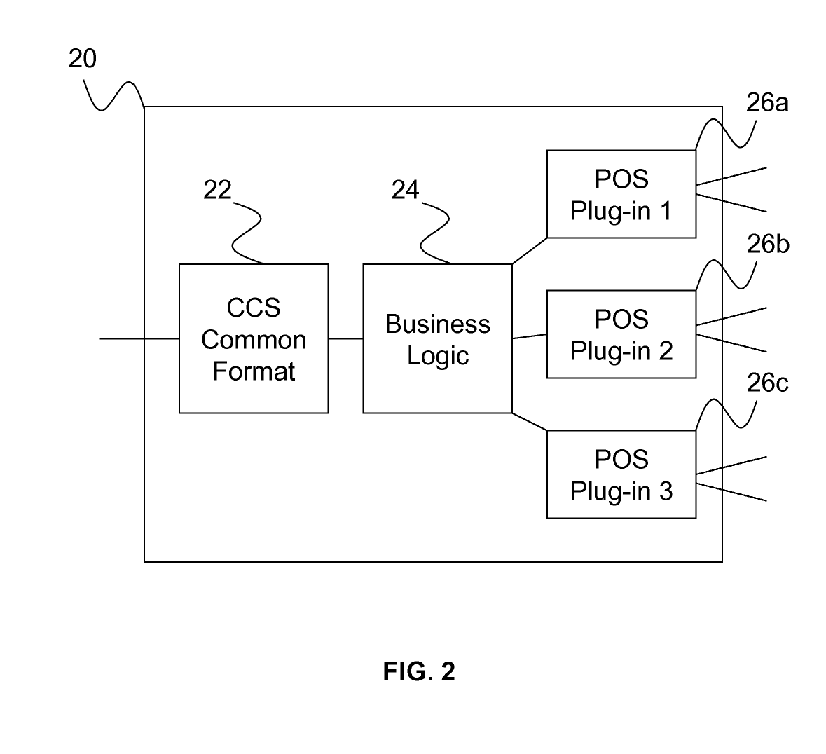

Reference is now made to FIG. 2 illustrating a block diagram of the PIS 20. As shown, the PIS 20 includes a CCS common format unit 22 for communicating with the CCS 10. In addition, the PIS 20 also includes a series of POS plug-in units 26 for communicating with the plurality of POS systems 20. The link between the CCS common format 22 and each POS plug-in unit 26 may be converted and/or translated by a business logic unit 24. In one embodiment, a processing command (e.g., creating and managing coupons) may be transmitted from the CCS 10 to the plurality of POS systems 30 via the plurality of plug-in units 26. In some instances, each plug-in 26 may be configured to work with a specific system type. For example, when the CCS 10 sends an action to the PIS 20, the CCS 10 identifies the specific POS system 30 (e.g., POS identifier) for which the CCS 10 is trying to communicate with. For example, the CCS 10 may be interested in communicating with the POS systems 30 of retailers or outlet merchants. In other embodiments, the types of communication may include POS type, IP or host name, login, password, authentication key, encryption key or security certificate, among others. In some instances, the communication may also include the contents of the coupon. For example, the contents may include coupon type, coupon category, coupon format, coupon location, coupon demographics and coupon value, among others. In some embodiments, the communication may further define which POS plug-in 26 may be designated for communicating with the POS system 30 (e.g., POS plug-in 26a to POS system A 30a, POS plug-in 26b to POS system B 30b, POS plug-in 26c to POS system C 30c).

In one embodiment, a processing command (e.g., creating and managing coupon) may be converted by the business logic unit 24 into a protocol specific format or language understood by the POS system 30. The processing command may also be converted into a CCS common format 22. The converted processing command may subsequently be relayed to the designated POS system 30 by the respective plug-in unit 26 it is in communication with. In another embodiment, when a response is received from the designated POS system 30, it may be relayed to the PIS 20 through the respective plug-in unit 26. In some instances, the communication between the POS system 30 and the respective plug-in unit 26 includes a common format and/or language understood by both. In other instances, the POS system 30 may relay success or failure of the processing command (e.g., coupon used, coupon not used), among other information. In some embodiments, before the PIS 20 is able to relay the feedback response to the CCS 10, the feedback response may be translated into a CCS common format 22 by the business logic 24 and subsequently transmitted to the CCS 10.

In other embodiments, each POS plug-in 26 is capable of supporting two-way communications protocols supported by the POS system 30 including file transfer via HTTP, FTP, SCP or AS2, web service calls, message protocol over open socket connection, among others. In other embodiments, each POS plug-in 26 may also be configured to manage the message traffic timing and quantity as defined by the service requirements.

Coupon Creation and Management

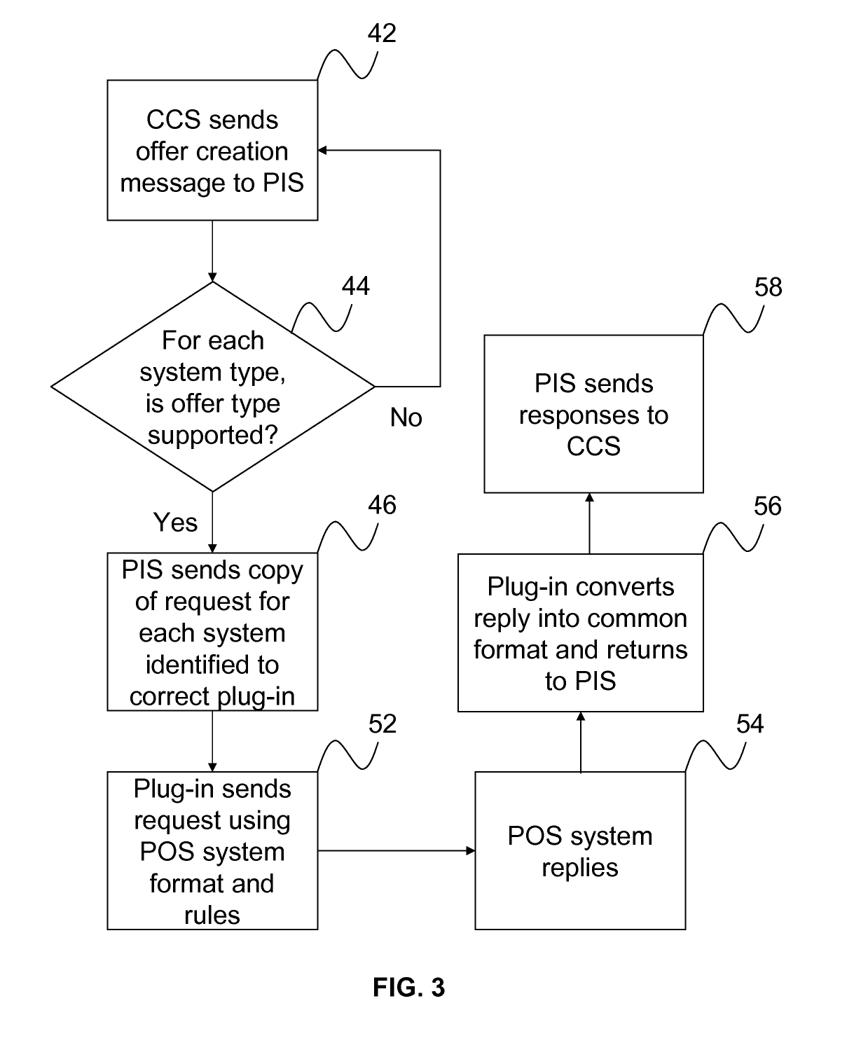

Reference is now made to FIG. 3 illustrating a flow diagram of a method of creating and managing coupons. In this embodiment, coupon creation and management begins in block 42 with the CCS 10 sending an offer creation message to the PIS 20. In some instances, the CCS 10 may also be referred to as a central coupon module and the PIS 20 may be referred to as an integration module, where the integration module is in communication with the central coupon module. The coupons being created may contain the following details, including but not limited to: coupon type (e.g., amount of dollar off, percentage of discount, buy one get one free, buy two get two free, percentage of basket off/discount), coupon face value, coupon max value, purchase requirement count, reward quantity count, offer code, product family code, billing code, UPC (universal product code)/GTIN (global trade item number) list and UPC/GTIN discount list. In some embodiments, the coupon may include coupon contents including the likes of at least one of coupon type, coupon category, coupon format, coupon location, coupon demographics and coupon value, among others.

In some embodiments, at least one coupon content may apply to each plug-in unit 26 along with other custom values managed by the plug-in unit 26 including without limitation unique identifiers for each transaction and/or offer. As discussed above, a plurality of plug-in units 26 may be housed within the PIS 20 or the integration module. In one instance, the coupon contents may be sent by the CCS 10 to the PIS 20 along with a set of POS system identifiers for transmitting the list to. In block 44, a plug-in unit 26 is capable of verifying the coupon contents. For each system type, the plug-in unit 26 determines whether or not the offer type is supported or not. Each plug-in 26, when registering with the PIS 20, may indicate which coupon types and fields it supports, while attempts to create offers not support by the target system (e.g., POS systems) may result in a failure code from the PIS 20 to the CCS 10. For instance, if a dollar discount coupon content is supplied to the plug-in unit 26 but not supported by the POS system 30, the offer type is rejected and a failure code may be transmitted from the PIS 20 to the CCS 10. On the other hand, if a percentage off discount coupon content is supplied to the plug-in unit 26 and supported by the POS system 30, the PIS 20 will send a copy of the request for each POS system 30 identified to the correct plug-in unit 26 as shown in block 46.

Similar to that discussed and shown in previous figures, a plurality of point-of-service (POS) systems 30 may be in communication with the PIS 20, whereby each POS system 30 is in communication with at least one plug-in unit 26. In one embodiment, each POS system 30 is capable of receiving the coupon content from the PIS 30 via the plug-in unit 26. The phrase POS system 30 and POS module may be interchangeable. In one embodiment, a POS module is capable of receiving at least one coupon content from the integration module via a plug-in unit.

Next, the PIS 20 sends a common format request to each plug-in unit 26 for each system type identified along with the list of systems to transmit the coupon to as shown in block 52. In this embodiment, the plug-in unit 26 is sending the request to the POS system 30 using POS system 30 formats and rules. In this embodiment, the targeted and/or identified systems are the POS system 30 and/or POS modules. Each plug-in unit 26 may convert the common format into the POS system 30 specific format, with or without assistance of the CCS common format module 22 and/or the business logic module 24. Once converted, the POS system 30 specific format may be applied and transmitted to the POS system 30 with transmission rules including without limitation: batching multiple requests, timing between each request, sending requests at specific times, and before transmitting the data over the POS system 30 specific protocol, among others. In one embodiment, the plug-in unit 26 is capable of transmitting the coupon content from the central coupon module to the POS module in a commonly recognized, universal format.

In response, the POS system 30 may reply by sending a feedback response as shown in block 54. The feedback response provided may include but is not limited to: a unique identifier within the POS system 30, a success code, a success message, a failure code, a failure message, a list of UPC/GTIN's that were approved along with product names and sizes, a list of reward UPC/GTIN's that were approved along with product names and sizes as well as any data about UPC/GTIN's that were added by the POS system 30 and reason codes for their addition, among other feedback messages. In turn, each plug-in unit 26 may convert the feedback response message into a common format and return the same to the PIS 20 as shown in block 56. In other words, the POS module is capable of transmitting the utilization (e.g., success, failure) of the coupon content to the central coupon module via the integration module. In block 58, the PIS 20 will relay or communicate the feedback response with all associated data to the CCS 10.

User Identifier Validation

Reference is now made to FIG. 3 illustrating a flow diagram of a method of verifying user identifier. Another process that can be carried out by the electronic coupons system is that of validating a user identifier. In one embodiment, a user needs to be identified at the POS system 30 so their specific offers can be looked up. The identifier could include but is not limited to: loyalty card, credit card, phone number, barcode or other identifier, biometric identification, near field communication (NFC) transmitting ID of one of the previous or any other unique identifier. The user identifier that is provided to the CCS 10 needs to be validated to insure it can be used in later steps. In block 62, the CCS 10 sends the user identifier and the user identifier type along with the system identifier to validate the user identifier against to the PIS 20. In block 64, the PIS 20 determines which plug-in unit 26 will do the validation and passes the value and the value type to the plug-in unit 26 along with any connection details. In block 66, the validation may be carried out by the plug-in unit 26 which validates as much as possible without connecting to the POS system 10, including but not limited to identifier length, identifier pattern and character set, and checksum algorithm. In one embodiment, if any test fails, an error message is returned and the process is returned to block 62. In another embodiment, if the test passes the plug-in unit 26 validation checks, the values are converted to the common format that may be validated in the POS system 30 and an identifier along with other information may be created for the POS system 30 for later use. In block 52, the plug-in unit 26 is able to send the request to the POS system 30 using the POS system's format and rules.

In block 54, the POS system 30 returns a success or failure message, along with one or more optional unique ID's and supporting data that map to the passed identifier. The message communicated from the POS system 30 to the PIS 20 may be similar to those described herein. In block 56, the values communicated from the POS system may be transmitted to the CCS 10, which has the plug-in units 26 converting the feedback response into common format and returns to the PIS 20, which may then be routed to the CCS 10 in block 58. In one embodiment, the CCS 10 may determine which returned identifier may be used for further communication if more than one is returned, assuming the passed identifier is not the one used for future communication.

Coupon Association

In one embodiment, when the CCS 10 needs to associate an offer created in the first process with a user identifier that was validated in the second process, it sends an offer association request in the common format to the PIS 20. This includes, but is not limited to the fields: system identifier, user identifier, coupon identifier and, optionally, overriding expiration date. In another embodiment, the PIS 20 sends the message to the correct plug-in unit 26 with the system connection details. In one embodiment, the plug-in unit 26 formats the data and sends it to the POS system 30 and returns a success or failure code and optional failure message, which are reported back to the PIS 20 in the common format and, in turn, to the CCS 10.

Redemption Report

In one embodiment, after redemption is completed in the POS system 30, it may report back, in real-time or near real-time, batched or otherwise, the transaction to its specific POS plug-in unit 26 within the PIS 20. The report data can include but is not limited to: transaction ID, user identifier, coupon identifier, date time stamp, total offer value, store ID, group ID, terminal ID, and cashier ID. The POS plug-in unit 26 accepts the incoming data and transforms it into the common redemption format before passing it to the PIS 20 which, in turn, passes it to the CCS 10.

System Monitoring Format

In addition to the above four interfaces, in another embodiment, each POS plug-in unit 26 may have a monitoring and administration common interface that can be used to check basic statistics, system status and other data about a specific POS system 30 connection. In some instances, this data may be collated by the PIS 20 and may be used to drive status reports and system monitors to maintain the electronic coupon system. In some embodiments, this interface may support but is not limited to: heartbeat check to confirm connection is live, test message transmission and confirmation, timing until next scheduled communication, total communication sessions and performance.

Coupon Distribution

Another embodiment of the present disclosure discusses a process by which actionable coupons, discount codes and/or other types of offers may be made available to external parties who display and allow users to take action on them.

In one embodiment, a method of distributing coupons begins with creating or inputting a coupon having at least one coupon content by an external party. In some instances, the external party members are most likely vendors or retailers of goods and/or services. In one embodiment, the CCS 10 may contain details on all available offers, discount or other type of savings with details including but not limited to: name of merchant providing discount, banner images in various formats and sizes designed for various media reflecting merchant's name, logo or other defining characterizes, one or more categories describing the merchant, searchable text describing the merchant, a list of locations of merchant stores, and if applicable, including the geo-coded values of the address, store hours, merchant type (e.g., physical, online, phone-in), specific offers available and for each offer: offer title, offer details text (e.g., in different lengths, formats for different platforms and media types), one or more categories for the offer, keywords for the offer, product images in various sizes, offer redemption details, start and expiration date, usage requirements, unique identification identifying the offer, short message service (SMS) keyword reflecting the offer, demographic or other delivery restrictions on the offer, demographic or delivery preferences on the offer. In some embodiments, in addition to the coupon content discussed above, a coupon may also contain coupon contents having at least one of type, category, format, location and demographics.

External parties (e.g., merchants or retailers) who want to display one or more specific offers to a user or set of users (e.g., customers) in any form of digital, print, radio or TV media can make specific requests of the CCS 10 for a coupon having the desired coupon contents. In one embodiment, the external party may need to first authenticate to the CCS 10 using a username and password which may be matched against a pre-established account. In one embodiment, the authenticating the status of the external party may coincide with the external party inputting a coupon content creation and/or request. An external party account may include but is not limited to: username, password, contact details, accounts details including what kind of payments are due for what kind of actions, types, merchants or other limitations to what offers they can display and limitations on how many offers they can request.

Once authenticated, the external party may make a request for the specific offer or types of offer they are interested in presenting to a user. This request can include but is not limited to: location limitations (including zip code, street address or lat/long), category(s) of interest, search terms, coupon type, demographics (age, gender, etc.), specific offer ID requested, unique user identifier already in the CCS 10, purchase history of the user or other user action history, how many results are requested, how close a fit is needed, media and platform formatting details including type, width and height restrictions, formatting restrictions (e.g. special characters and font size).

Once the CCS 10 receives the request it does the following. First, if an offer identification is provided, it confirms that the external party has access to that offer and returns the offer information as defined later. Otherwise, the CCS 10 takes the provided information and searches the coupon contents to determine the best fit coupons. In one embodiment, the CCS 10 matches the coupon content requested to a plurality of coupons on its database. In one example, this may work as follows: any offers not permitted to be delivered to the external party or not of a type requested by the external party may be removed from the possible result set. They can also be removed if the financial or revenue sharing deals in place do not allow for offers of the specific type. If location data is provided, offers not within a reasonable distance of the provided location may be removed from consideration. If demographic data is provided, offers may be removed that filter specific demographic information. The remaining data may then be ranked. In another example, this may work as follows: a base score is assigned to each coupon and adjusted based on provided data including: category matching, keyword matching, user history either by resolving the unique ID provided into history already in the CCS 10 or user history provided with the request.

In one embodiment, a score may be assigned to each of the plurality of coupons on the database accessed by the CCS 10, with the score based on the goodness of the match, wherein each score is assigned based on at least one of type, category, format, location, demographics, keyword and number matches. For example, a merchant may be requesting a 10% off coupon. The database may contain a listing of 5% off coupon, 50% off coupon, and $20 off coupon. The 5% off coupon may be assigned with a higher score than the 50% off coupon and the $20 off coupon, while the 50% off coupon may or may not be assigned with a higher score than the $20 off coupon depending on the other input criteria presented by the merchant when the coupon content request was entered.

Subsequently, each of the plurality of coupons may be displayed to one user or a set of users based on the assigned scores. In some instances, the assigned scores may be ranked with the display being from highest to lowest. In another embodiment, the status of the one user or a set of users may be authenticated. In other words, the coupons may not be displayed to the user or set of users if he or she is not a member of the external party (e.g., warehouse membership).

In other embodiments, once an ordered list is generated, the top scores are compared against match requirements. In one embodiment, if the top scored item does not match the request with the confidence requested in the request, no results may be returned. In another embodiment, the top results are returned, but no more than the maximum results requested and no results that are outside of the match requirements. In one embodiment, the coupons that did not reach a confidence level during the matching, assigning or ranking steps may be filtered and not displayed. In some instances, the confidence level may be at least about 80%, or at least about 90%, or at least about 95%.

In one embodiment, for each result, some subset of the coupon content data in the CCS 10 may be returned, the fields depending on the data provided. One of the factors may be media type, which defines which fields are provided for that specific media as well as the media size (e.g. what size banners, which text fields of which length, which media is included). For example, a print media may take a large image and a custom keyword while a mobile banner may take a banner ad, offer details and an identifier to use to generate an action link. In one embodiment, the external third party may subsequently display the coupon containing the coupon content as per the requirements of their specific platform.

Logging

There may be several levels of display and interaction that may be reported to the CCS 10 for correct tracking and revenue generating events.

In one embodiment, for print, radio, TV or other non-interactive media, a reporting call may be made back to the CCS 10 given the estimated distribution numbers for the offer (e.g., coupon). No other specific data may be logged until the media is viewed and action is taken by sending an SMS message to the CCS 10 with a specific code on the media indicating an interest in the offer. This may be logged as a clip request (see below).

In one embodiment, for interactive media, several calls may be made. All calls may be authenticated and identified as described above. First, a reporting call is made when the summary (e.g., banner/title) is displayed to a user. This reporting call includes but is not limited to: offer ID, user identifier, display location (e.g., where, within the external parties properties or user experience was the offer displayed), timestamp of display, and time in seconds offer was visible.

In one embodiment, if the user takes action to view more information on a specific offer, that call may also logged including but not limited to: offer ID, user identifier, display location, timestamp, seconds offer details was viewed for.

In one embodiment, if the user indicates any additional information about the offer, including but not limited to: a ranking (e.g., 1 star, 2 stars, 5 stars), user identifier, an explicit positive or negative view (e.g., thumbs up/down) on the offer, a ranking of explicit view on the category, merchant or type of offer, may also be logged.

Clipping Call

In one embodiment, another interaction that a user can take with an offer is indicating whether they want to redeem this specific offer now or later. If the user indicates a desire to do so, the external party informs the CCS 10. This message to the CCS includes but is not limited to: offer ID, user identifier, timestamp, display location, and type of action, among others. In one embodiment, the offer may be placed in the user's mailbox on the CCS 10 so they can access it via other platforms for redemption or tracking purposes.

Although the disclosure has been described in detail with reference to several embodiments, additional variations and modifications exist within the scope and spirit of the disclosure as described and defined in the following claims.

What is claimed is:

1. A system for creating and managing coupons, the system comprising:
a central coupon module capable of creating a coupon, wherein the coupon comprises a coupon content;
an integration module in communication with the central coupon module, wherein the integration module comprises a plug-in unit, and wherein the plug-in unit is configured to verify the coupon content; and
a point-of-sales (POS) module in communication with the plug-in unit of the integration module, wherein the POS module is capable of receiving the coupon content from the integration module via the plug-in unit.

2. The system of claim 1, wherein the coupon content includes at least one of coupon type, coupon category, coupon format, coupon location, coupon demographics and coupon value.

3. The system of claim 1, wherein the plug-in unit is operable to transmit the coupon content from the central coupon module to the POS module in a common format.

4. The system of claim 1, wherein the POS module is operable to transmit utilization of the coupon content to the central coupon module via the integration module.

5. A method comprising:
(a) inputting a coupon content by a first user;
(b) matching the coupon content to a plurality of coupons;
(c) assigning a score to each of the plurality of coupons based on the matching step (b), wherein each score is assigned based on matches directed to at least one of coupon type, coupon category, coupon format, coupon location, coupon demographics, coupon keyword and coupon value; and
(d) displaying each of the plurality of coupons based on the assigned scores from the assigning step (c) to a second user.

6. The method of claim 5, further comprising, concomitant to the inputting step (a), authenticating the status of the first user.

7. The method of claim 5, wherein the coupon content comprises at least one of coupon type, coupon category, coupon format, coupon location, coupon demographics and coupon value.

8. The method of claim 5, concomitant to the assigning step (c), ranking the scores from highest to lowest.

9. The method of claim 5, further comprising, concomitant to the displaying step (d), authenticating the status of the second user.

10. The method of claim 5, further comprising, concomitant to the displaying step (d), filtering the coupons that did not reach a confidence level during the matching step (b).

11. The method of claim 10, wherein the confidence level is at least about 80%.
